(19) United States
(12) Patent Application Publication
(10) Pub. No.: US 2025/0006940 A1
(43) Pub. Date: Jan. 2, 2025

(54) CONDUCTIVE PIGMENT PASTE, MIXTURE PASTE, AND ELECTRODE FOR LITHIUM ION BATTERY

(71) Applicant: KANSAI PAINT CO., LTD., Amagasaki-shi, Hyogo (JP)

(72) Inventors: Satoru FURUSAWA, Hiratsuka-shi, Kanagawa (JP); Rikuya SUZUKI, Hiratsuka-shi, Kanagawa (JP)

(21) Appl. No.: 18/692,980

(22) PCT Filed: Sep. 22, 2022
(86) PCT No.: PCT/JP2022/035291

§ 371 Date: Mar. 18, 2024

(30) Foreign Application Priority Data
Sep. 23, 2021 (JP) 2021-154941
Sep. 21, 2022 (JP) 2022-150053

(51) Int. Cl. H01M 4/62; H01M 4/02; H01M 4/131; H01M 10/0525

(52) U.S. Cl. CPC H01M 4/625; H01M 4/131; H01M 10/0525; H01M 2004/021

(57) ABSTRACT

A conductive pigment paste contains a pigment dispersion resin (A), a conductive pigment (B), a solvent (C), a fluororesin (D), and a high-polarity low-molecular weight component (E). The pigment dispersion resin (A) contains at least one polar functional group selected from the group consisting of an amide group, an imide group, a hydroxyl group, a carboxyl group, a sulfonate group, a phosphate group, a silanol group, a cyano group, and a pyrrolidone group. A concentration of the polar functional group in the pigment dispersion resin (A) is 0.3 mmol/g or greater and 23 mmol/g or less. The conductive pigment (B) contains carbon nanotubes (B1). The high-polarity low-molecular weight component (E) contains an amine compound (E1). The conductive pigment paste can be use for a mixture paste and a lithium ion battery electrode.

### TECHNICAL FIELD

The present invention relates to a conductive pigment paste and a mixture paste that excel in pigment dispersibility and storage stability even at a high pigment concentration, and also relates to an electrode for a lithium ion battery, the electrode being coated with the mixture paste.

### BACKGROUND ART

Conventionally, paste-like pigment dispersions in which a pigment is dispersed in a mixture of a pigment dispersion resin, a solvent, and the like have been widely used in various fields. In these fields, demands for improvements in performance properties such as pigment dispersibility, storage stability, coatability, conductivity, finish properties, and solvent resistance are increasing, and thus pigment dispersion resins and pigment pastes having excellent pigment dispersibility and excellent storage stability sufficient for preventing re-aggregation of pigment particles in the formed pigment dispersion are being developed.

In designing a pigment paste, it is important to reduce the usage amounts of the solvent and pigment dispersion resin such that the pigment dispersion resin does not adversely affect the performance of the final product such as an electrode. Furthermore, from the viewpoint of reducing the energy that is used in drying, it is also important to create a highly concentrated and uniformly dispersed pigment paste with a small amount of a pigment dispersion resin. Moreover, it is also important that the pigment paste can be stored for a long period of time without deteriorating.

Under such circumstances, Patent Literature 1 describes a carbon nanotube dispersion liquid containing bundled-type carbon nanotubes, a dispersion medium, and a polyvinyl butyral having a weight average molecular weight of greater than 50000. In a D50 particle diameter distribution, the diameters of the dispersed particles of the bundled-type carbon nanotubes are from 3 to 10 μm.

However, while an electrode slurry containing the carbon nanotube dispersion liquid, an electrode active material, and a binder resin exhibits good performance such as initial dispersibility and viscosity, in some cases the electrode slurry may not have sufficient long-term storage performance.

### CITATION LIST

### Patent Literature

Patent Literature 1: JP 2018-535284 T

### SUMMARY OF INVENTION

### Technical Problem

The issue to be solved by the present invention is to provide a conductive pigment paste and a mixture paste that exhibit excellent storage stability and have excellent pigment dispersibility and appropriate viscosity (low viscosity) even at high pigment concentrations, and to also provide a lithium ion battery electrode that excels in various performance properties (such as battery performance).

### Solution to Problem

The present inventors conducted diligent examinations to solve the above issue, and as a result, discovered that the issue can be solved by a conductive pigment paste containing a pigment dispersion resin (A), a conductive pigment (B), a solvent (C), a fluororesin (D), and a high-polarity low-molecular weight component (E), in which the pigment dispersion resin (A) contains at least one polar functional group selected from the group consisting of an amide group, an imide group, a hydroxyl group, a carboxyl group, a sulfonate group, a phosphate group, a silanol group, a cyano group, and a pyrrolidone group, a concentration of the polar functional group in the pigment dispersion resin (A) is 0.3 mmol/g or greater and 23 mmol/g or less, the conductive pigment (B) contains carbon nanotubes (B1), and the high-polarity low-molecular weight component (E) contains an amine compound (E1), and thereby the present inventors arrived at the present invention.

That is, the present invention provides the following conductive pigment paste, mixture paste, and electrode for a lithium ion battery.

[Aspect 1] A conductive pigment paste containing:
a pigment dispersion resin (A);
a conductive pigment (B);
a solvent (C);
a fluororesin (D); and
a high-polarity low-molecular weight component (E),
in which
the pigment dispersion resin (A) contains at least one polar functional group selected from the group consisting of an amide group, an imide group, a hydroxyl group, a carboxyl group, a sulfonate group, a phosphate group, a silanol group, a cyano group, and a pyrrolidone group, and a concentration of the polar functional group in the pigment dispersion resin (A) is 0.3 mmol/g or greater and 23 mmol/g or less,
the conductive pigment (B) contains carbon nanotubes (B1), and
the high-polarity low-molecular weight component (E) contains an amine compound (E1).

[Aspect 2] The conductive pigment paste according to aspect 1, in which a content of the amine compound (E1) is 12 mass % or greater and 500 mass % or less based on a solid content of the conductive pigment (B) being 100 mass %.

[Aspect 3] The conductive pigment paste according to aspect 1 or 2, in which an acidic group content of the carbon nanotubes (B1) is 0.01 mmol/g or greater and 0.5 mmol/g or less.

[Aspect 4] The conductive pigment paste according to any one of aspects 1 to 3, in which a median diameter (D50) in terms of volume of the carbon nanotubes (B1) is 10 μm or greater and 250 μm or less.

[Aspect 5] The conductive pigment paste according any one of aspects 1 to 4, in which a BET specific surface area of the carbon nanotubes (B1) is 100 m²/g or greater and 800 m²/g or less, and
a ratio of G/D is 0.1 or greater and 5.0 or less, where, in a Raman spectrum of the carbon nanotubes (B1), G is a maximum peak intensity in a range of 1560 cm⁻¹ or greater and 1600 cm⁻¹ or less, and D is a maximum peak intensity in a range of 1310 cm⁻¹ or greater and 1350 cm⁻¹ or less.

[Aspect 6] The conductive pigment paste according to any one of aspects 1 to 4, in which a moisture content of the solvent (C) is 1 mass % or less and an amine compound content of the solvent (C) is 1 mass % or less.

[Aspect 7] The conductive pigment paste according to any one of aspects 1 to 6, in which a weight average molecular weight of the amine compound (E1) is less than 1000.

[Aspect 8] The conductive pigment paste according to any one of aspects 1 to 7, in which an amine value of the amine compound (E1) is 105 mgKOH/g or greater and 1000 mgKOH/g or less.

[Aspect 9] The conductive pigment paste according to any one of aspects 1 to 8, in which the solvent (C) is N-methyl-2-pyrrolidone.

[Aspect 10] The conductive pigment paste according to any one of aspects 1 to 9, in which the conductive pigment (B) further contains acetylene black.

[Aspect 11] A mixture paste produced by blending the conductive pigment paste described in any one of aspects 1 to 10 and an electrode active material (F).

[Aspect 12] A mixture paste containing:
a pigment dispersion resin (A);
a conductive pigment (B);
a solvent (C);
a fluororesin (D);
a high-polarity low-molecular weight component (E); and
an electrode active material (F),
in which
the pigment dispersion resin (A) contains at least one polar functional group selected from the group consisting of an amide group, an imide group, a hydroxyl group, a carboxyl group, a sulfonate group, a phosphate group, a silanol group, a cyano group, and a pyrrolidone group, and a concentration of the polar functional group in the pigment dispersion resin (A) is 0.3 mmol/g or greater and 23 mmol/g or less,
the conductive pigment (B) contains carbon nanotubes (B1), and
the high-polarity low-molecular weight component (E) contains an amine compound (E1).

[Aspect 13] A lithium ion battery electrode produced using the mixture paste described in aspect 11 or 12.

### Advantageous Effects of Invention

The conductive pigment paste and the mixture paste of the present invention exhibit excellent pigment dispersibility and appropriate viscosity (low viscosity) even at a high pigment concentration, and also excel in storage stability and conductivity of a coating film. Furthermore, a lithium ion battery electrode produced by applying the mixture paste excels in various performance properties (such as battery performance).

### DESCRIPTION OF EMBODIMENTS

Hereinafter, embodiments for carrying out the present invention will be described in detail.

Note that it should be understood that the present invention is not limited to the following embodiments and includes various modified examples carried out without departing from the gist of the present invention.

Furthermore, in the present invention, a “specific surface area” is a BET specific surface area measured by a nitrogen adsorption method.

In the present invention, first, a conductive pigment paste containing a conductive pigment in an appropriately dispersed state is adjusted. Further, in order to produce a lithium ion battery electrode that satisfies various performance properties, a mixture paste is produced by adding components such as an electrode active material to the conductive pigment paste.

### [Conductive Pigment Paste]

The conductive pigment paste of the present invention is a paste of a conductive pigment and contains a pigment dispersion resin (A), a conductive pigment (B), a solvent (C), a fluororesin (D), and a high-polarity low-molecular weight component (E). The pigment dispersion resin (A) contains at least one polar functional group selected from the group consisting of an amide group, an imide group, a hydroxyl group, a carboxyl group, a sulfonate group, a phosphate group, a silanol group, a cyano group, and a pyrrolidone group. A concentration of the polar functional group in the pigment dispersion resin (A) is 0.3 mmol/g or greater and 23 mmol/g or less. The conductive pigment (B) contains carbon nanotubes (B1). The high-polarity low-molecular weight component (E) contains an amine compound (E1).

### Pigment Dispersion Resin (A)

The pigment dispersion resin (A) has at least one polar functional group selected from the group consisting of an amide group, an imide group, a hydroxyl group, a carboxyl group, a sulfonate group, a phosphate group, a silanol group, a cyano group, and a pyrrolidone group. A concentration of the polar functional group in the pigment dispersion resin (A) is 0.3 mmol/g or greater and 23 mmol/g or less. Also, the abovementioned acid groups may be in the form of a salt.

The type of resin is not particularly limited as long as it is a resin other than the fluororesin (D) described below. Examples of the resin include acrylic resins, polyester resins, epoxy resins, polyether resins, alkyd resins, urethane resins, polyvinyl alcohol, polyvinyl acetal, polyvinyl pyrrolidone, polyvinyl acetate, silicone resins, polycarbonate resins, chlorine-based resins, and composite resins thereof. A single type of these resins can be used alone, or two or more types thereof can be used in combination.

From viewpoints such as pigment dispersibility, storage stability, and finish properties, among these resins, a vinyl (co)polymer (A1) produced by polymerizing or copolymerizing a monomer including a polymerizable unsaturated group-containing monomer represented by Formula (1) is preferably contained as the pigment dispersion resin (A). Note that the term “(co)polymer” in the present invention includes both a polymer produced by polymerizing one type of monomer and a copolymer produced by copolymerizing two or more types of monomers.

C(—R)₂═C(—R)₂ Formula (1)

[In the above formula, each R may be the same or different and represents a hydrogen atom or an organic group.]

The vinyl (co)polymer (A1) preferably contains in the structure thereof a structural unit represented by “—CH₂—CH(—X)—” (provided that X is an active hydrogen group or an organic group containing an active hydrogen group). Examples of the vinyl (co)polymer (A1) include a hydroxyl group-containing vinyl (co)polymer, a carboxyl group-containing vinyl (co)polymer, an amide group-containing vinyl (co)polymer, a sulfonate group-containing vinyl (co)polymer, a phosphate group-containing vinyl (co)polymer, and a pyrrolidone group-containing vinyl (co)polymer. A single type of these (co)polymers can be used alone or two or more types thereof can be used in a combination.

Examples of the hydroxyl group-containing vinyl (co)polymer include polyhydroxyethyl (meth)acrylate, polyvinyl alcohol, a vinyl alcohol-fatty acid vinyl copolymer, a vinyl alcohol-ethylene copolymer, a vinyl alcohol-(N-vinylformamide) copolymer, and a copolymer of hydroxyethyl (meth)acrylate and another polymerizable unsaturated monomer. The vinyl alcohol unit in the (co)polymer may be one produced by (co)polymerizing a fatty acid vinyl unit and then subjecting to hydrolysis.

Examples of the carboxyl group-containing vinyl (co)polymer include a polymer of (meth)acrylic acid, or a copolymer of poly (meth)acrylic acid and another polymerizable unsaturated monomer.

Examples of the amide group-containing vinyl (co)polymer include a polymer of (meth)acrylamide, or a copolymer of (meth)acrylamide and another polymerizable unsaturated monomer.

Examples of the sulfonate group-containing vinyl (co)polymer include a polymer of allyl sulfonic acid or styrene sulfonic acid, and a copolymer of allyl sulfonic acid and/or styrene sulfonic acid and another polymerizable unsaturated monomer.

Examples of the phosphate group-containing vinyl (co)polymer include a polymer of a (meth)acryloyloxyalkyl acid phosphate, or a copolymer of (meth)acryloyloxyalkyl acid phosphate and another polymerizable unsaturated monomer.

In addition to the above-described structural unit represented by “—CH₂—CH(—X)—”, the vinyl (co)polymer (A1) may contain, as necessary, a structural unit derived from a polymerizable unsaturated group-containing monomer that can be copolymerized. Examples of the polymerizable unsaturated group-containing monomer that can be copolymerized include vinyl carboxylate monomers, such as vinyl formate, vinyl acetate, vinyl propionate, isopropenyl acetate, vinyl valerate, vinyl caprylate, vinyl caprate, vinyl laurate, vinyl stearate, vinyl benzoate, vinyl versatate, and vinyl pivalate; olefins such as ethylene, propylene, and butylene; aromatic vinyls such as styrene and α-methylstyrene; ethylenically unsaturated alkyl carboxylate monomers such as methyl (meth)acrylate, ethyl (meth)acrylate, n-butyl (meth)acrylate, 2-ethylhexyl (meth)acrylate, dimethyl fumarate, dimethyl maleate, diethyl maleate, and diisopropyl itaconate; vinyl ether monomers such as methyl vinyl ether, n-propyl vinyl ether, isobutyl vinyl ether and dodecyl vinyl ether; halogenated vinyl monomers or vinylidene monomers, such as vinyl chloride, vinylidene chloride, vinyl fluoride and vinylidene fluoride; allyl compounds such as allyl acetate and allyl chloride; quaternary ammonium group-containing monomers such as 3-(meth)acrylamidopropyl trimethylammonium chloride; and vinyltrimethoxysilane, N-vinylformamide, (meth)acrylamide, and N-vinyl-2-pyrrolidone. A single type of these monomers can be used alone or two or more types thereof can be used in a combination.

Moreover, from the viewpoints of pigment dispersibility, storage stability, and miscibility with the solvent, ideally, the concentration of the polar functional group in the pigment dispersion resin (A) is usually 0.3 mmol/g or greater and preferably 9 mmol/g or greater, and is usually 23 mmol/g or less.

The vinyl (co)polymer (A1) can be produced by a known polymerization method, and for example, solution polymerization is preferably used. However, the polymerization method is not limited thereto, and bulk polymerization, emulsion polymerization, suspension polymerization, or the like may be used. When solution polymerization is used, continuous polymerization or batch polymerization may be carried out, and the monomers may be charged all at once or in portions, or may be added continuously or intermittently.

The polymerization initiator used in solution polymerization is not particularly limited, and specific examples of polymerization initiators that can be used include known radical polymerization initiators, including azo compounds such as azobisisobutyronitrile, azobis-2,4-dimethylvaleronitrile and azobis (4-methoxy-2,4-dimethylvaleronitrile); peroxides such as acetyl peroxide, benzoyl peroxide, lauroyl peroxide, acetylcyclohexylsulfonyl peroxide and 2,4,4-trimethylpentyl-2-peroxyphenoxyacetate; percarbonate compounds such as diisopupyl peroxydicarbonate, di-2-ethylhexyl peroxydicarbonate and diethoxyethyl peroxydicarbonate; perester compounds such as t-butyl peroxyneodecanoate, α-cumyl peroxyneodecanoate, and t-butyl peroxyneodecanoate; and azobis-dimethylvaleronitrile and azobis-methoxyvaleronitrile.

The polymerization reaction temperature is not particularly limited, and can usually be set in an approximate range or 30° C. or higher and 200° C. or less.

A degree of polymerization of the vinyl (co)polymer (A1) that can be produced as described above is, for example, 100 or greater, and preferably 150 or greater, and for example, 4000 or less, preferably 3000 or less, and more preferably 700 or less.

A weight average molecular weight is, for example, 1000 or greater, preferably 2000 or greater, and more preferably 7000 or greater, and for example, 2000000 or less, preferably 1000000 or less, and more preferably 500000 or less.

From perspectives such as finish properties and corrosion resistance, a weight average molecular weight of a modified epoxy resin of the present invention is normally in a range of 500 or greater, preferably 1000 or greater, and more preferably 1500 or greater, and is normally 50000 or less, preferably 20000 or less, and more preferably 10000 or less.

Note that in the present specification, unless otherwise specified, a weight average molecular weight is a value calculated by converting a retention time (retention capacity) measured using a gel permeation chromatograph (GPC) into a molecular weight of polystyrene using a retention time (retention capacity) of standard polystyrene having a known molecular weight measured under the same conditions. Specifically, a weight average molecular weight can be measured using the “HLC8120 GPC” (trade name, manufactured by Tosoh Corporation) as the gel permeation chromatograph, four columns, namely the “TSKgel G-4000HXL”, the “TSKgel G-3000HXL”, the “TSKgel G-2500HXL”, and the “TSKgel G-2000HXL” (trade names, all manufactured by Tosoh Corporation), and tetrahydrofuran as a mobile phase at a measurement temperature of 40° C., a flow rate of 1 m/min, and detector refractive index (RI) conditions.

By removing and/or replacing the solvent after the completion of synthesis, the vinyl (co)polymer (A1) can be made into a solid or a resin solution in which the original solvent has been replaced with an optionally selected solvent.

The solvent may be removed by heating at normal pressure or may be removed under reduced pressure. Moreover, as the method for replacing the solvent, a replacement solvent may be inserted before, during, or after removal of the original solvent.

### (Content of Pigment Dispersion Resin (A))

Based on a total solid content of the conductive pigment paste, a solid content of the pigment dispersion resin (A) is, for example, 0.1 mass % or greater, preferably 1 mass % or greater, and more preferably 3 mass % or greater, and is, for example, 40 mass % or less, preferably 20 mass % or less, and more preferably 15 mass % or less.

Moreover, based on a content of the conductive pigment (B), the solid content of the pigment dispersion resin (A) is, for example, 0.1 mass % or greater, preferably 1 mass % or greater, and more preferably 5 mass % or greater, and is, for example, 50 mass % or less, preferably 40 mass % or less, and more preferably 30 mass % or less.

### Conductive Pigment (B)

The conductive pigment (B) contains carbon nanotubes (B1).

The conductive pigment (B) may further contain other conductive pigments (B2) in addition to the carbon nanotubes (B1).

Based on 100 mass % of the conductive pigment (B), a content of the carbon nanotubes (B1) in the conductive pigment (B) is, for example, 50 mass % or greater, preferably 75 mass % or greater, and more preferably 95 mass % or greater.

### (Carbon Nanotube (B1))

As the carbon nanotubes (B1), either of single-walled carbon nanotubes or multi-walled carbon nanotubes can be used alone, or the two types of carbon nanotubes (B1) can be combined and used. In particular, from a relationship between viscosity, conductivity, and cost, multi-walled carbon nanotubes are preferably used.

An average outer diameter of the carbon nanotubes (B1) is, for example, 1 nm or greater, preferably 3 nm or greater, and more preferably 5 nm or greater, and is, for example, 30 nm or less, preferably 28 nm or less, and more preferably 25 nm or less.

The carbon nanotubes (B1) have an average length of, for example, 0.1 μm or greater, preferably 1 μm or greater, and more preferably 5 μm or greater, and for example, 100 μm or less, preferably 80 μm or less, and more preferably 60 μm or less.

From the relationship between viscosity and conductivity, a BET specific surface area of the carbon nanotubes (B1) is usually 100 m²/g or greater, preferably 130 m²/g or greater, and more preferably 160 m²/g or greater, and is usually 800 m²/g or less, preferably 600 m²/g or less, and more preferably 400 m²/g or less.

From the viewpoints of dispersibility and storage performance, an acidic group content in the carbon nanotubes (B1) is usually 0.01 mmol/g or greater, and preferably 0.01 mmol/g or greater, and is usually 1.0 mmol/g or less, preferably 0.5 mmol/g or less, more preferably 0.2 mmol/g or less, and even more preferably 0.1 mmol/g or less. When the acidic group content is 0.01 mmol/g or greater, dispersibility is good, and when the content thereof is 1.0 mmol/g or less, storage performance is good.

The acidic group can be added by the following acid treatment of the carbon nanotubes.

### <Acid Treatment Method>

An acid treatment method is not particularly limited as long as an acid can be brought into contact with the carbon nanotubes, but a method of immersing the carbon nanotubes in an acid treatment solution (an aqueous solution of an acid) is preferable. The acid contained in the acid treatment liquid is not particularly limited, and examples thereof include nitric acid, sulfuric acid, and hydrochloric acid. A single type of these acids can be used alone, or two or more types can be combined and used. Among these acids, nitric acid and sulfuric acid are preferable.

The acidic group content in the carbon nanotubes can be adjusted by the concentration of the acid treatment solution, the temperature, the treatment time, and the like.

After the acid treatment, excessive acid components adhering to the surface can be removed by a below-described washing method to thereby produce acid-treated carbon nanotubes.

The method for washing the acid-treated carbon nanotubes is not particularly limited, but rinsing with water is preferable. For example, carbon nanotubes are recovered from the acid-treated carbon nanotubes by a known method such as filtration, after which the carbon nanotubes are rinsed with water. After the washing, if necessary, water attached to the surface is removed by drying or the like to produce acid-treated carbon nanotubes.

When measured by the method described in Examples, a median diameter (D50) in terms of volume of the carbon nanotubes (B1) is usually 10 μm or greater, preferably 15 μm or greater, and more preferably 20 μm or greater, and is usually 250 μm or less, preferably 200 μm or less, and more preferably 150 μm or less. Here, the median diameter (D50) can be determined by irradiating particles of the carbon nanotubes with laser light and calculating, from the scattered light, the diameters of the carbon nanotubes in terms of conversion into spheres. A larger median diameter (D50) indicates that more aggregates of the carbon nanotubes are present, and dispersibility is worse. When the median diameter (D50) is greater than 250 μm, it is highly likely that aggregates of carbon nanotubes are present in the electrode, resulting in non-uniform conductivity throughout the electrode. When the median diameter (D50) is less than 10 μm, the fiber length is short, and therefore the conductive path is insufficient, and conductivity decreases. However, when the median diameter (D50) is in a range of 10 μm or greater and 250 μm or less, the carbon nanotubes can be uniformly dispersed in the electrode while maintaining conductivity.

A ratio of G/D is usually 0.1 or greater, preferably 0.4 or greater, and more preferably 0.6 or greater, and is usually 5.0 or less, preferably 3.0 or less, and more preferably 1.0 or less, where, in a Raman spectrum of the carbon nanotubes (B1), G is a maximum peak intensity in a range of 1560 cm⁻¹ or greater and 1600 cm⁻¹ or less, and D is a maximum peak intensity in a range of 1310 cm⁻¹ or greater and 1350 cm⁻¹ or less.

Here, when the G/D ratio is in a range of 0.1 or greater and 5.0 or less, crystal interfaces and defects on the carbon surface are few, and conductivity is likely to be high, and thus such a range is preferable.

### (Other Conductive Pigment (B2))

Examples of the other conductive pigment (B2) other than the carbon nanotubes (B1) include at least one type of conductive carbon selected from the group consisting of acetylene black, Ketjen black, furnace black, thermal black, graphene, and graphite. The other conductive pigment (B2) is preferably one or more types selected from the group consisting of acetylene black, Ketjen black, furnace black, and thermal black, more preferably one or more types selected from the group consisting of acetylene black and Ketjen black, and even more preferably one or more types of acetylene black.

An average primary particle size of the other conductive pigment (B2) is, for example, 10 nm or greater, and preferably 20 nm or greater, and is for example, 80 nm or less, and preferably 70 nm or less. Here, the average primary particle size refers to an average particle size of primary particles determined by observing the conductive carbon (B2) with an electron microscope, determining a projected surface area of each of 100 particles, deriving a diameter based on the assumption of a circle equal to the projected surface area, and simply averaging the diameters of the 100 particles. Note that when the pigment is in an aggregated state, the average primary particle size is calculated using the primary particles constituting the aggregated particles.

A BET specific surface area of the conductive carbon (B2) is not particularly limited. From the relationship between viscosity and conductivity, the BET specific surface area of the conductive carbon (B2) is, for example, 1 m²/g or greater, preferably 10 m²/g or greater, and more preferably 20 m²/g or greater, and is, for example, 500 m²/g or less, preferably 250 m²/g or less, and more preferably 200 m²/g or less.

A dibutyl phthalate (DBP) oil absorption amount of the conductive carbon (B2) is not particularly limited. From the relationship between pigment dispersibility and conductivity, the DBP oil absorption amount is, for example, 60 mL/100 g or more, and preferably 150 mL/100 g or more, and is, for example, 1000 mL/100 g or less, and preferably 800 mL/100 g or less.

### (Content of Conductive Pigment (B))

From the perspectives of conductivity and pigment dispersibility and on the basis of the total solid content of the conductive pigment paste, the solid content of the conductive pigment (B) is, for example, 10.0 mass % or greater, preferably 30.0 mass % or greater, and more preferably 40.0 mass % or greater, and is for example, 99.0 mass % or less, preferably 80.0 mass % or less, and more preferably 60.0 mass % or less.

### Solvent (C)

Water, various organic solvents, and the like can be suitably used as the solvent (C).

Specific examples of the solvent (C) include hydrocarbon solvents such as n-butane, n-hexane, n-heptane, n-octane, cyclopentane, cyclohexane, and cyclobutane; aromatic solvents such as toluene, and xylene; ketone-based solvents such as methylisobutylketone; ether-based solvents such as n-butylether, dioxane, ethylene glycol monomethylether, ethylene glycol monoethylether, ethylene glycol monobutylether, and diethylene glycol; ester-based solvents such as ethyl acetate, n-butyl acetate, isobutyl acetate, ethylene glycol monomethylether acetate, and butylcarbitol acetate; ketone-based solvents such as methylethylketone, methylisobutylketone, and diisobutylketone; alcohol-based solvents such as such as ethanol, isopropanol, n-butanol, sec-butanol, and isobutanol; and amide-based solvents such as EQUAMIDE (trade name, amide-based solvent manufactured by Idemitsu Kosan Co., Ltd.), N,N-dimethylformamide, N,N-dimethylacetamide, N-methylformamide, N-methylacetamide, N-methylpropionamide, and N-methyl-2-pyrrolidone.

Among these, an amide-based solvent is preferable, and N-methyl-2-pyrrolidone is more preferable. A single type of these solvents can be used alone, or two or more types thereof can be used in combination.

In addition, from the viewpoints of pigment dispersibility of the conductive pigment paste and prevention of deterioration or hydrolysis of the resin component, the solvent (C) is preferably substantially free of water. Here, “substantially free of water” means that the content of water in relation to the total amount of the conductive pigment paste is usually 1 mass % or less, preferably 0.5 mass % or less, and particularly preferably 0.1 mass % or less.

In the present invention, a water content of the conductive pigment paste can be measured by a Karl Fischer coulometric titration method. Specifically, the water content can be measured by using a Karl Fischer moisture titrator (trade name: MKC-610, manufactured by Kyoto Electronics Manufacturing Co., Ltd.) and setting a temperature of the evaporator (ADP-611, manufactured by Kyoto Electronics Manufacturing Co., Ltd.) provided in the moisture titrator to 130° C.

When an amide-based compound (solvent) such as N-methyl-2-pyrrolidone is used, an amine component may be contained as an impurity, and in the conductive pigment paste of the present invention, a viscosity or a thickening tendency may vary from lot to lot depending on the amine component present as an impurity.

In addition, when the conductive pigment paste of the present invention is formed into an electrode layer by a method described below, the solvent or the like is volatilized and thus does not remain. However, it is preferable to recover and reuse the volatilized solvent in order to reduce waste, be environmentally-friendly, and/or reduce raw material costs. That is, using a recycled product as the solvent (C) is preferable. The recycled solvent (recycled product) also contains the amine compound (E1) originally contained in the conductive pigment paste of the present invention, and similarly, the viscosity or the thickening tendency of the conductive pigment paste may vary from lot to lot. In addition, amine compounds often have a strong odor.

Therefore, it is preferable to manage and adjust a content of the amine compound in the recycled solvent (C) to a certain amount or less, and the content of the amine compound is usually 1 mass % or less, preferably 0.5 mass % or less, and particularly preferably 0.1 mass % or less.

“Using a recycled product as the solvent (C)” means that 10 mass % or greater (preferably 20 mass % or greater) of the recycled product is contained in the solvent (C) used in the conductive pigment paste of the present invention.

On the basis of the total amount of the conductive pigment paste, a content of the solvent (C) in the conductive pigment paste is, for example, 40 mass % or greater, preferably 60 mass % or greater, and more preferably 80 mass % or greater, and is, for example, 99 mass % or less, preferably 98 mass % or less, and more preferably 97 mass % or less.

From the viewpoint of a solubility of the resin, a solubility parameter δA of the pigment dispersion resin (A) and a solubility parameter δC of the solvent (C) preferably satisfy a relational expression of |δA-δC|<2.0. The solubility parameter δC of the solvent (C) itself is, for example, in a range of 10.0 or greater, and preferably 10.5 or greater, and for example, 12.0 or less, and preferably 11.5 or less.

A solubility parameter of the resin is numerically quantified on the basis of a turbidity measurement method known to a person skilled in the art, and specifically, can be determined according to an equation stipulated by K. W. SUH and J. M. CORBETT (Journal of Applied Polymer Science, 12, 2359, 1968).

A solubility parameter of the solvent can be determined according to the method described in the VII Solubility Parameter Values section on pp. 519-559 of the “Polymer Handbook” edited by J. Brandrup and E. H. Immergut (John Wiley & Sons, 3rd edition, published in 1989).

When two or more types of solvents (C) are used in combination as a mixed solvent, a solubility parameter of the mixed solvent can be determined experimentally, or can be determined through a simple method from the sum of products of the mole fractions and the solubility parameters of the individual liquid solvents.

Note that in the present invention, the unit of the solubility parameter is “(cal/cm³)^{1/2}”

### Fluororesin (D)

The fluororesin (D) is a resin for forming a film of the electrode layer.

As the fluororesin (D), polyvinylidene fluoride (PVDF) is particularly preferable, and a single type thereof can be used alone, or two or more types can be used in combination.

The fluororesin (D) may be contained at pigment dispersion or may be added and contained after the pigment is dispersed. From the viewpoints of adhesion to a substrate, reinforcement of film physical properties, and solvent resistance, a weight average molecular weight of the fluororesin (D) is, for example, 100000 or greater, preferably 500000 or greater, more preferably 650000 or greater, and for example, 3000000 or less, preferably 2000000 or less.

On the basis of the solid content of the conductive pigment paste, the content of the fluororesin (D) is, for example, 10.0 mass % or greater, preferably 30.0 mass % or greater, and more preferably 40.0 mass % or greater, and for example, 99.0 mass % or less, preferably 80.0 mass % or less, and more preferably 60.0 mass % or less.

### High-Polarity Low-Molecular Weight Component (E)

The high-polarity low-molecular weight component (E) contains an amine compound (E1) from the viewpoint of improving wettability of the conductive pigment and/or storage stability.

A content of the amine compound (E1) in the highly-polarity low-molecular weight component (E) is, for example, 50 mass % or greater, preferably 75 mass % or greater, and more preferably 95 mass % or greater, based on 100 mass % of the high-polarity low-molecular weight ingredient (E).

Examples of the amine compound (E1) include ammonia, primary amines, secondary amines, and tertiary amines.

Examples of primary amines include primary monoamines such as ethylamine, n-propylamine, sec-propylamine, n-butylamine, sec-butylamine, i-butylamine, tert-butylamine, pentylamine, hexylamine, heptylamine, octylamine, decylamine, laurylamine, mystylamine, 1,2-dimethylhexylamine, 3-pentylamine, 2-ethylhexylamine, allylamine, aminoethanol, 1-aminopropanol, 2-aminopropanol, aminobutanol, aminopentanol, aminohexanol, 3-ethoxypropylamine, 3-propoxypropylamine, 3-isopropoxypropylamine, 3-butoxypropylamine, 3-isobutoxypropylamine, 3-(2-ethylhexyloxy)propylamine, aminocyclopentane, aminocyclohexane, aminonorbomene, aminomethylcyclohexane, aminobenzene, benzylamine, phenethylamine, α-phenylethylamine, naphthylamine, and furfurylamine; and primary polyamines such as ethylenediamine, 1,2-diaminopropane, 1,3-diaminopropane, 1,2-diaminobutane, 1,3-diaminobutane, 1,4-diaminobutane, 1,5-diaminopentane, 1,6-diaminohexane, 1,7-diaminoheptane, 1,8-diaminooctane, dimethylaminopropylamine, diethylaminopropylamine, bis-(3-aminopropyl)ether, 1,2-bis-(3-aminopropoxy)ethane, 1,3-bis-(3-aminopropoxy)-2,2′-dimethylpropane, aminoethylethanolamine, 1,2-bisaminocyclohexane, 1,3-bisaminocyclohexane, 1,4-bisaminocyclohexane, 1,3-bisaminomethylcyclohexane, 1,4-bisaminomethylcyclohexane, 1,3-bisaminoethylcyclohexane, 1,4-bisaminoethylcyclohexane, 1,3-bisaminopropylcyclohexane, 1,4-bisaminopropylcyclohexane, hydrogenated 4,4′-diaminodiphenyl methane, 2-aminopiperidine, 4-aminopiperidine, 2-aminomethylpiperidine, 4-aminomethylpiperidine, 2-aminoethylpiperidine, 4-aminoethylpiperidine, N-aminoethylpiperidine, N-aminopropylpiperidine, N-aminoethylmorpholine, N-aminopropylmorpholine, isophoronediamine, methanediamine, 1,4-bisaminopropylpiperazine, o-phenylenediamine, m-phenylenediamine, p-phenylenediamine, 2,4-tolylenediamine, 2,6-tolylenediamine, 2,4-toluenediamine, m-aminobenzylamine, 4-chloro-o-phenylenediamine, tetrachloro-p-xylylenediamine, 4-methoxy-6-methyl-m-phenylenediamine, m-xylylenediamine, p-xylylenediamine, 1,5-naphthalenediamine, 2,6-naphthalenediamine, benzidine, 4,4′-bis(o-toluidine), dianisidine, 4,4′-diaminodiphenylmethane, 2,2-(4,4′-diaminodiphenyl)propane, 4,4′-diaminodiphenylether, 4,4;-thiodianiline, 4,4′-diaminodiphenyl sulfone, 4,4′-diaminoditolyl sulfone, methylene bis(o-chloroaniline), 3,9-bis(3-aminopropyl)2,4,8,10-tetraoxaspiro[5,5]undecane, diethylene triamine, imino bispropylamine, methyl imino bispropylamine, bis(hexamethylene)triamine, triethylenetetramine, tetraethylenepentamine, pentaethylenehexamine, N-aminoethylpiperazine, N-aminopropylpiperazine, 1,4-bis(aminoethylpiperazine), 1,4-bis(aminopropylpiperazine), 2,6-diaminopyridine, and bis(3,4-diaminophenyl)sulfone.

Examples of secondary amines include secondary monoamines such as diethylamine, dipropylamine, di-n-butylamine, di-sec-butylamine, diisobutylamine, di-n-pentylamine, di-3-pentylamine, dihexylamine, dioctylamine, di(2-ethylhexyl)amine, methylhexylamine, diallylamine, pyrrolidine, piperidine, 2,4-lupetidine, 2,6-lupetidine, 3,5-lupetidine, diphenylamine, N-methylaniline, N-ethylaniline, dibenzylamine, methylbenzylamine, dinaphthylamine, pyrrole, indoline, indole, and morpholine; and secondary polyamines such as N,N′-dimethylethylenediamine, N,N′-dimethyl-1,2-diaminopropane, N,N′-dimethyl-1,3-diaminopropane, N,N′-dimethyl-1,2-diaminobutane, N,N′-dimethyl-1,3-diaminobutane, N,N′-dimethyl-1,4-diaminobutane, N,N′-dimethyl-1,5-diaminopentane, N,N′-dimethyl-1,6-diaminohexane, N,N′-dimethyl-1,7-diaminoheptane, N,N′-diethylethylenediamine, N,N′-diethyl-1,2-diaminopropane, N,N′-diethyl-1,3-diaminopropane, N,N′-diethyl-1,2-diaminobutane, N,N′-diethyl-1,3-diaminobutane, N,N′-diethyl-1,4-diaminobutane, N,N′-diethyl-1,6-diaminohexane, piperazine, 2-methylpiperazine, 2,5-dimethylpiperazine, 2,6-dimethylpiperazine, homopiperazine, 1,1-di-(4-piperidyl)methane, 1,2-di-(4-piperidyl)ethane, 1,3-di-(4-piperidyl)propane, and 1,4-di-(4-piperidyl)butane.

Examples of tertiary amines include tertiary monoamines such as trimethylamine, triethylamine, tri-n-propylamine, tri-iso-propylamine, tri-1,2-dimethylpropylamine, tri-3-methoxypropylamine, tri-n-butylamine, tri-iso-butylamine, tri-sec-butylamine, tri-pentylamine, tri-3-pentylamine, tri-n-hexylamine, tri-n-octylamine, tri-2-ethylhexylamine, tri-dodecylamine, tri-laurylamine, dicyclohexylethylamine, cyclohexyldiethylamine, tri-cyclohexylamine, N,N-dimethylhexylamine, N-methyldihexylamine, N,N-dimethylcyclohexylamine, N-methyldicyclohexylamine, N,N-diethylethanolamine, N,N-dimethylethanolamine, N-ethyldiethanolamine, triethanolamine, tribenzylamine, N,N-dimethylbenzylamine, diethylbenzylamine, triphenylamine, N,N-dimethylamino-p-cresol, N,N-dimethylaminomethyl phenol, 2-(N,N-dimethylaminomethyl)phenol, N,N-dimethylaniline, N,N-diethylaniline, pyridine, quinoline, N-methylmorpholine, N-methylpiperidine, 2-(2-dimethylaminoethoxy)-4-methyl-1,3,2-dioxabornane, and 2-, 3-, 4-picoline; and tertiary polyamines such as tetramethylethylenediamine, pyrazine, N,N′-dimethylpiperazine, N,N′-bis((2-hydroxy)propyl)piperazine, hexamethylenetetramine, N,N,N′,N′-tetramethyl-1,3-butaneamine, 2-dimethylamino-2-hydroxypropane, diethylaminoethanol, N,N,N-tris(3-dimethylaminopropyl)amine, 2,4,6-tris(N,N-dimethylaminomethyl)phenol, and heptamethyl isobiguanide.

One type of these amine compounds (E1) can be used alone, or two or more types thereof can be used in combination.

Among these, the amine compound (E1) preferably does not contain another functional group such as an acid group or a hydroxyl group, a primary amine compound is preferable, and a monovalent amine compound (monoamine) is preferable.

Examples of the amine compound (E1) include aliphatic amines, alicyclic amines, and aromatic amines, and any of these can be suitably used, but aromatic amines are preferable.

Preferably, no amine compound remains in the electrode layer after drying, and therefore, a weight average molecular weight of the amine compound (E1) is preferably less than 1000, more preferably 800 or less, still more preferably 500 or less, and particularly preferably 350 or less. For the same reason, a boiling point of the amine compound is preferably 400° C. or lower, more preferably 300° C. or lower, and even more preferably 200° C. or lower.

An amine value of the amine compound (E1) is usually in a range of 5 mgKOH/g or greater, preferably 50 mgKOH/g or greater, and more preferably 105 mgKOH/g or greater, and usually 1000 mgKOH/g or less.

As another high-polarity low-molecular weight component, for example, one or more types of acidic high-polarity low-molecular weight components selected from organic acids and inorganic acids can be used in combination with the amine compound (E1). Further, one or more types of basic high-polarity low-molecular weight components selected from organic bases and inorganic bases can be used.

Examples of the organic acid include organic carboxylic acids (such as formic acid, acetic acid, propionic acid, benzoic acid, and phthalic acid) and organic sulfonic acids (such as benzenesulfonic acid), and examples of the inorganic acid include hydrochloric acid, sulfuric acid, nitric acid, and phosphoric acid.

Examples of the organic base include a base component other than an amine compound, and examples of the inorganic base include metal hydroxides (such as sodium hydroxide and potassium hydroxide).

Based on 100 mass % of the solid content of the conductive pigment paste, the content of the high-polarity low-molecular weight component (E) is, for example, 1 mass % or greater, preferably 10 mass % or greater, and more preferably 40 mass % or greater, and for example, 600 mass % or less, preferably 500 mass % or less, more preferably 200 mass % or less, and even more preferably 150 mass % or less.

Moreover, the lower limit of the content of the high-polarity low-molecular weight component (E) based on 100 mass % of the solid content of the conductive pigment (B) is, for example, 1 mass % or, preferably 12 mass % or greater, more preferably 40 mass % or greater, and still more preferably 80 mass % or greater. The upper limit is, for example, 1000 mass % or less, preferably 500 mass % or less, more preferably 350 mass % or less, and still more preferably 300 mass % or less.

The high-polarity low-molecular weight component (E) (and in particular, the amine compound (E1)) has a strong odor in many cases, and thus the working environment may be deteriorated during blending or in a drying process. In addition, because the component (E) is generally expensive, an increase in cost may occur. Therefore, it is necessary to set a content of the component (E) to the minimum necessary level.

A content ratio of the solvent (C) to the high-polarity low-molecular weight component (E) in terms of a mass ratio of the solvent (C) to the high-polarity low-molecular weight component (E) is usually in a range from 100/0.1 to 100/10, preferably in a range from 100/0.5 to 100/8, more preferably in a range from 100/1 to 100/6, and even more preferably in a range from 100/1.5 to 100/4.

When α (parts by mass) is the content of the high-polarity low-molecular weight component (E) relative to 100 parts by mass of the content of the conductive pigment (B), and β (m²/g) is the BET specific surface area of the conductive pigment (B), the value of X in Equation (1) is in a range of usually 5 or greater, preferably 10 or greater, more preferably 40 or greater, and even more preferably 60 or greater, and usually 2500 or less, preferably 1000 or less, more preferably 500 or less, and even more preferably 300 or less.

X=α/β×300 Equation (1)

It was discovered that, within this range, the surface of the conductive pigment (B) can be sufficiently wetted with the high-polarity low-molecular weight component (E), and the dispersibility (including viscosity) and storage stability (including a suppression of thickening) of the conductive pigment (B) can be improved.

When the abovementioned upper limit range is exceeded, the content of the high-polarity low-molecular weight component (E) in relation to the surface area of the conductive pigment (B) is excessive (leading to an increase in odor and cost), and when the content is less than the lower limit range described above, a content of the high-polarity low-molecular weight component (E) in relation to a surface area of the conductive pigment (B) is insufficient.

### Other Components

In addition to the components (A), (B), (C), (D), and (E), other components can be contained, as necessary, in the conductive pigment paste of the present invention.

Examples of such other components include a resin other than the pigment dispersion resin (A) and the fluororesin (D), as well as a neutralizing agent, an antifoaming agent, an antiseptic agent, a rust inhibitor, a plasticizer, and a pigment other than the conductive pigment (B).

Examples of the pigment other than the conductive pigment (B) include white pigments, such as titanium white and zinc white; blue pigments, such as cyanine blue and indanthrene blue; green pigments, such as cyanine green and verdigris; organic red pigments, such as azo-based and quinacridone-based pigments; red pigments, such as red iron oxide; organic yellow pigments, such as benzimidazolone-based, isoindolinone-based, isoindoline-based, and quinophthalone-based pigments; and yellow pigments, such as titanium yellow, and chrome yellow. A single type of these pigments can be used alone, or two or more types thereof can be used in combination. These pigments other than the conductive pigment (B) can be used for purposes such as adjusting the color or reinforcing the physical properties of the film within a range that does not significantly impair the conductivity, and may be simultaneously dispersed together with the pigment dispersion resin (A) and the conductive pigment (B), or may be mixed as a pigment or a pigment paste after the pigment dispersion resin (A) and the conductive pigment (B) have been dispersed to form a paste.

A content of the pigment other than the conductive pigment (B) is preferably 10 mass % or less, more preferably 5 mass % or less, and even more preferably 1 mass % or less, based on the total amount of pigments in the conductive pigment paste, and particularly preferably, the conductive pigment paste is substantially free of a pigment other than the conductive pigment (B).

From the viewpoints of pigment dispersibility and storage stability, a viscosity of the conductive pigment paste at a shear rate of 2 s⁻¹ is, for example, less than 5000 mPa·s, preferably less than 2500 mPa·s, and more preferably less than 1000 mPa·s, and for example, 10 mPa·s or higher, preferably 50 mPa·s or higher, and more preferably 100 mPa·s.

The viscosity can be measured using, for example, a cone & plate type viscometer (trade name “Mars 2”, manufactured by Haake, diameter: 35 mm, cone & plate inclined at 2°).

The conductive pigment paste of the present invention can be prepared by uniformly mixing and dispersing the above-described components using a known disperser such as a paint shaker, a sand mill, a ball mill, a pebble mill, an LMZ mill, a DCP pearl mill, a planetary ball mill, a homogenizer, a twin-screw kneader, or a thin-film spin type high-speed mixer (trade name “ClearMix”, manufactured by Filmix).

### [Mixture Paste (for Lithium Ion Battery Electrode)]

The present invention provides a mixture paste produced by further blending an electrode active material (F) into the conductive pigment paste. The mixture paste is suitably used for a positive electrode or a negative electrode for use as an electrode of a lithium ion battery, and is preferably used in a positive electrode.

Further, the production method (the order in which the components are mixed) of the second aspect of the mixture paste of the present invention is not limited as long as the mixture paste contains a pigment dispersion resin (A), a conductive pigment (B), a solvent (C), a fluororesin (D), a high-polarity low-molecular weight component (E), and an electrode active material (F), the pigment dispersion resin (A) contains at least one polar functional group selected from the group consisting of an amide group, an imide group, a hydroxyl group, a carboxyl group, a sulfonate group, a phosphate group, a silanol group, and a cyano group, a concentration of the polar functional group in the pigment dispersion resin (A) is 0.3 mmol/g or greater and 23 mmol/g or less, the conductive pigment (B) contains carbon nanotubes (B1), and the high-polarity low-molecular weight component (E) contains an amine compound (E1).

### Electrode Active Material (F)

Examples of the electrode active material (F) include lithium composite oxides such as lithium nickelate (LiNiO₂), lithium manganate (LiMn₂O₄), lithium cobaltate (LiCoO₂), and LiNi_{1/3}Co_{1/3}Mn_{1/3}O₂; lithium iron phosphate (LiFePO₄); sodium composite oxides; and potassium composite oxides. A single type of these electrode active materials (F) can be used alone, or two or more types thereof can be mixed and used. The electrode active material containing the lithium iron phosphate is inexpensive and has relatively good cycle characteristics and energy density, and therefore can be suitably used.

A particle diameter of the electrode active material is usually 0.5 μm or greater, and preferably 10.5 μm or greater, and usually 30 μm or less, and preferably 20 μm or less.

From perspectives such as battery capacity and battery resistance, a solid content of the electrode active material (F) in the solid content of the mixture paste of the present invention for a lithium ion battery electrode is usually 70 mass % or greater, and preferably 80 mass % or greater, and is less than 100 mass %.

When the electrode active material (F) is contained in the mixture paste, the viscosity may increase through storage. This may be because the electrode active material (F) has an alkali metal hydroxide (for example, LiOH, KOH, or NaOH) derived from the raw material on the particle surface, and thus is aggregated (thickened) by the conductive pigment (B) having an acidic surface. Therefore, thickening during storage of the mixture paste can be suppressed by containing a certain amount or more of the high-polarity low-molecular weight component (E) (in particular, the amine compound (E1)).

### Production of Mixture Paste

The mixture paste of the present invention can be produced by first preparing the above-described conductive pigment paste, and then blending at least one type of electrode active material (F) into the paste.

In addition, the mixture paste of the present invention may be prepared by mixing the above-described components (A), (B), (C), (D), and (E), and the electrode active material (F).

Preferably, from viewpoints such as battery performance and paste viscosity, a solid content of the pigment dispersion resin (A) in a solid content of the mixture paste of the present invention is usually 0.01 mass % or greater, and preferably 0.02 mass % or greater, and is usually 20 mass % or less, and preferably 10 mass % or less.

Furthermore, from the viewpoint of storage stability (suppressing thickening) of the mixture paste of the present invention, the mixture paste contains the high-polarity low-molecular weight component (E), and contains at least one type of amine compound (E1) as the high-polarity low-molecular weight component (E).

From the viewpoint of reducing aggregation between the conductive pigment (B) and the electrode active material (F) by bringing the high-polarity low-molecular weight component (E) into contact with (wetting) the conductive pigment (B) and then mixing the electrode active material (F), the conductive pigment (B) is preferably first mixed with the high-polarity low-molecular weight component (E).

In the mixture paste of the present invention, from the viewpoint of storage stability (suppression of thickening) of the mixture paste, a preferable lower limit of a content of the high-polarity low-molecular weight component (E) based on 100 mass % of a solid content of the conductive pigment (B) is usually 1 mass % or greater, preferably 10 mass % or greater, more preferably 40 mass % or greater, and still more preferably 80 mass % or greater. From the viewpoint of an amount of the component (E) remaining in an electrode film, an upper limit of the content of the component (E) is usually 500 mass % or less, preferably 400 mass % or less, more preferably 350 mass % or less, and even more preferably 300 mass % or less.

From the viewpoint of battery performance, the solid content of the conductive pigment (B) in the solid content of the mixture paste of the present invention is usually 0.01 mass % or greater, preferably 0.05 mass % or greater, and more preferably 0.1 mass % or greater, and usually 30 mass % or less, preferably 20 mass % or less, and more preferably 15 mass % or less. From the viewpoint of electrode drying efficiency and paste viscosity, a content of the solvent (C) in the mixture paste of the present invention is usually 1 mass % or greater, preferably 5 mass % or greater, and more preferably 10 mass % or greater, and usually 70 mass % or less, preferably 60 mass % or less, and more preferably 50 mass % or less.

### [Lithium Ion Battery Electrode]

### Production of Lithium Ion Battery Electrode

As described above, an electrode mixture layer (also referred to as an electrode layer or a mixture layer) of a lithium ion secondary battery can be produced by applying a mixture paste for a lithium ion battery electrode onto a core material surface of a positive electrode or a negative electrode and drying the mixture paste, but the mixture paste is particularly preferably used for a positive electrode.

The conductive pigment paste of the present invention can be used not only as a paste for a mixture layer, but also as a paste for a primer layer between an electrode core material and a mixture layer.

The mixture paste for a lithium ion battery electrode can be applied by a known method using a die coater or the like. A coating amount of the mixture paste for a lithium ion battery electrode is not particularly limited, and can be set such that a thickness of the dried mixture layer is in a range of, for example, 0.04 mm or greater, and preferably 0.06 mm or greater, and for example, 0.30 mm or less, and preferably 0.24 mm or less. A temperature of the drying process can be appropriately set within a range of, for example, 80° C. or higher, and preferably 100° C. or higher, and, for example, 200° C. or lower, and preferably 180° C. or lower. The time of the drying process can be appropriately set within a range of, for example, 5 seconds or more and, for example, 120 seconds or less, and preferably 60 seconds or less.

In the drying process, some or all of the solvent (C) and the high-polarity low-molecular weight component (E) are volatilized, but as described above, the volatilized components (C) and (E) are preferably recovered and reused for the purpose of reducing waste, being environmentally friendly, and/or reducing costs.

Hereinafter, the present invention will be described in more detail with reference to examples, but the present invention is not limited to these specific embodiments.

### EXAMPLES

### [Production of Pigment Dispersion Resin]

### Production Example 1: Sulfonic Acid-Modified Polyvinyl Alcohol Resin

A reaction vessel equipped with a thermometer, a reflux condenser tube, a nitrogen gas inlet tube, and a stirrer was charged with 97 parts by mass of vinyl acetate and 3.0 parts by mass of sodium allysulfonate as polymerizable monomers, methanol as a solvent, and azobisisobutyronitrile as a polymerization initiator, and the materials were subjected to a copolymerization reaction at a temperature of approximately 60° C., after which the unreacted monomers were removed under reduced pressure, and a resin solution was produced. Subsequently, a methanol solution of sodium hydroxide was added to carry out a saponification reaction, and the product was thoroughly washed and then dried with a hot air dryer. Finally, a sulfonic acid-modified polyvinyl alcohol resin having a weight average molecular weight of 17000, a polar functional group concentration of 18.1 mmol/g, and a saponification degree of 90 mol % was produced.

### [Production of Conductive Pigment Paste and Mixture Paste]

### Example 1A

40 parts (solid content: 40 parts) of the sulfonic acid-modified polyvinyl alcohol resin produced in Production Example 1, 200 parts of carbon nanotubes (CNT1), 180 parts of KF polymer W #7300 (trade name, manufactured by Kureha Corporation, polyvinylidene fluoride, weight average molecular weight: 1000000), 9380 parts of N-methyl-2-pyrrolidone (NMP1), and 200 parts of benzylamine were mixed and then dispersed in a ball mill for 5 hours, and a conductive pigment paste (A-1) was thereby produced.

### Example 1B

900 parts of active material particles (lithium nickel manganese oxide particles having a spinel structure and represented by the compositional formula LiNi_{0.5}Mn_{1.5}O₄, average particle size: 6 μm, BET specific surface area: 0.7 m²/g) were mixed with 100 parts of the above conductive pigment paste (A-1) using a disperser, and a mixture paste (B-1) was thereby produced.

### Examples 2A to 20A and Comparative Examples 1A and 2A

Conductive pigment pastes (A-2) to (A-22) according to Examples 2A to 20A and Comparative Examples 1A and 2A were produced in the same manner as in Example 1A with the exception that the formulations shown in Tables 1 and 2 were used.

### Examples 2B to 20B and Comparative Examples TB and 2B

Mixture pastes (B-2) to (B-22) according to Examples 2B to 20B and Comparative Examples TB and 2B were produced in the same manner as in Example TB with the exception that the formulations were as shown in Table 3 below.

TABLE 1

| | | Examples and Comparative Examples | | | | | | | | | | |
|---|---|---|---|---|---|---|---|---|---|---|---|---|
| | | Examples | | | | | | | | | | |
| | | 1A | 2A | 3A | 4A | 5A | 6A | 7A | 8A | 9A | 10A | 11A |
| Conductive pigment paste name | | A-1 | A-2 | A-3 | A-4 | A-5 | A-6 | A-7 | A-8 | A-9 | A-10 | A-11 |
| (A) | Dispersion resin A-1 | 40 | | | | 20 | 60 | 40 | 40 | 40 | 40 | 40 |
| | Dispersion resin A-2 | | 40 | | | | | | | | | |
| | Dispersion resin A-3 | | | 40 | | | | | | | | |
| | Dispersion resin A-4 | | | | 40 | | | | | | | |
| | Dispersion resin A-5 | | | | | | | | | | | |
| (B) | CNT1 | 200 | 200 | 200 | 200 | 200 | 200 | | | | | |
| | CNT2 | | | | | | | 200 | | | | |
| | CNT3 | | | | | | | | 200 | | | |
| | CNT4 | | | | | | | | | 200 | | |
| | CNT5 | | | | | | | | | | 200 | |
| | CNT6 | | | | | | | | | | | 200 |
| (E) | Amine 1 | | | | | | | | | | | |
| | Amine 2 | 200 | 200 | 200 | 200 | 200 | 200 | 200 | 200 | 200 | 200 | 200 |
| | Amine 3 | | | | | | | | | | | |
| | Amine 4 | | | | | | | | | | | |
| (C) | NMP1 | 9380 | 9380 | 9380 | 9380 | 9400 | 9360 | 9380 | 9380 | 9380 | 9380 | 9380 |
| | NMP2 | | | | | | | | | | | |
| | PGMME | | | | | | | | | | | |
| SP value difference (\|δA − δC\|) | | 1.9 | 0.3 | 3 | 1.7 | 1.9 | 1.9 | 1.9 | 1.9 | 1.9 | 1.9 | 1.9 |
| Evaluation | Dispersibility | A | A | B | A | B | A | A | C | A | A | A |
| | Initial viscosity | A | A | B | A | B | A | A | B | A | A | A |
| | Storage Stability | S | S | B | S | B | S | S | S | S | A | B |

TABLE 2

| | | Examples and Comparative Examples | | | | | | | | | | |
|---|---|---|---|---|---|---|---|---|---|---|---|---|
| | | | | | | | | | | | Comparative | |
| | | Examples | | | | | | | | | Examples | |
| | | 12A | 13A | 14A | 15A | 16A | 17A | 18A | 19A | 20A | 1A | 2A |
| Conductive pigment paste name | | A-12 | A-13 | A-14 | A-15 | A-16 | A-17 | A-18 | A-19 | A-20 | A-21 | A-22 |
| (A) | Dispersion resin A-1 | 40 | 40 | 40 | 40 | 40 | 40 | 40 | 40 | 40 | 40 | |
| | Dispersion resin A-2 | | | | | | | | | | | |
| | Dispersion resin A-3 | | | | | | | | | | | |
| | Dispersion resin A-4 | | | | | | | | | | | |
| | Dispersion resin A-5 | | | | | | | | | | | 40 |
| (B) | CNT1 | 200 | 200 | 200 | 200 | 200 | 200 | 200 | 200 | 200 | 200 | 200 |
| | CNT2 | | | | | | | | | | | |
| | CNT3 | | | | | | | | | | | |
| | CNT4 | | | | | | | | | | | |
| | CNT5 | | | | | | | | | | | |
| | CNT6 | | | | | | | | | | | |
| (E) | Amine 1 | | | | | 200 | | | | | | |
| | Amine 2 | 10 | 40 | 120 | 400 | | | | 200 | 200 | | 200 |
| | Amine 3 | | | | | | 200 | | | | | |
| | Amine 4 | | | | | | | 200 | | | | |
| (C) | NMP1 | 9570 | 9540 | 9460 | 9180 | 9380 | 9380 | 9380 | | | 9580 | 9380 |
| | NMP2 | | | | | | | | 9380 | | | |
| | PGMME | | | | | | | | | 9380 | | |
| SP value difference (\|δA − δC\|) | | 1.9 | 1.9 | 1.9 | 1.9 | 1.9 | 1.9 | 1.9 | 1.9 | 2.6 | 1.9 | 1.9 |
| Evaluation | Dispersibility | B | A | A | A | A | A | B | A | B | A | D |
| | Initial viscosity | A | A | A | A | A | A | B | A | B | A | D |
| | Storage Stability | C | B | A | S | A | B | B | A | A | D | C |

TABLE 3

| | Examples and Comparative Examples | | | | | | | | | | |
|---|---|---|---|---|---|---|---|---|---|---|---|
| | Examples | | | | | | | | | | |
| | 1B | 2B | 3B | 4B | 5B | 6B | 7B | 8B | 9B | 10B | 11B |
| Mixture Paste Name | B-1 | B-2 | B-3 | B-4 | B-5 | B-6 | B-7 | B-8 | B-9 | B-10 | B-11 |
| Conductive pigment | A-1 | A-2 | A-3 | A-4 | A-5 | A-6 | A-7 | A-8 | A-9 | A-10 | A-11 |
| paste name | | | | | | | | | | | |
| | Examples and Comparative Examples | | | | | | | | | | |
| | | | | | | | | | | Comparative | |
| | Examples | | | | | | | | | Examples | |
| | 12B | 13B | 14B | 15B | 16B | 17B | 18B | 19B | 20B | 1B | 2B |
| Mixture Paste Name | B-12 | B-13 | B-14 | B-15 | B-16 | B-17 | B-18 | B-19 | B-20 | B-21 | B-22 |
| Conductive pigment | A-12 | A-13 | A-14 | A-15 | A-16 | A-17 | A-18 | A-19 | A-20 | A-21 | A-22 |
| paste name | | | | | | | | | | | |

The details of each component in Table 1 and Table 2 are as shown in Tables 4 to 6 below.

### <Pigment Dispersion Resin (A)>

TABLE 4

| | | Weight average | Functional | |
|---|---|---|---|---|
| | | molecular | group | |
| | | weight | concentration | SP |
| Pigment Dispersion Resin Name | | (Mw) | (mmol/g) | value |
| A-1 | Sulfonic acid-modified | 17000 | 18.1 | 13 |
| | polyvinyl alcohol | | | |
| A-2 | Polyvinyl alcohol | 15000 | 9.9 | 10.8 |
| | (saponification degree: | | | |
| | 60 mol %) | | | |
| A-3 | Polyacrylamide | 12000 | 12 | 14.1 |
| A-4 | Polyvinylpyrrolidone | 15000 | 9 | 12.8 |
| A-5 | Polymethyl methacrylate | 15000 | 0 | 9.23 |

### <Carbon Nanotube (B)>

TABLE 5

| | Average | | Median | | Specific | Acidic |
|---|---|---|---|---|---|---|
| | particle | Average | diameter | | surface | group |
| CNT | size | length | D50 | G/D | area | content |
| Name | (nm) | (μm) | (μm) | ratio | (m²/g) | (mmol/g) |
| CNT1 | 8 | 17 | 30 | 0.7 | 300 | 0.02 |
| CNT2 | 13 | 40 | 40 | 0.7 | 180 | 0.04 |
| CNT3 | 10 | 2 | 200 | 0.9 | 280 | 0.01 |
| CNT4 | 150 | 6 | 15 | 0.14 | 13 | 0.03 |
| CNT5 | 13 | 40 | 40 | 0.7 | 180 | 0.15 |
| CNT6 | 13 | 40 | 40 | 0.7 | 180 | 0.25 |

CNT1 to CNT6 were all multi-walled carbon nanotubes.

The median diameter (D50), the G/D ratio, and the acidic group content described in Table 5 were measured by the following methods.

### <Median Diameter (D50)>

The median diameter (D50) was measured according to the following procedures using the “LA-960” (trade name, manufactured by Horiba, Ltd.) laser diffraction-scattering particle size distribution analyzer.

### [Preparation of Aqueous Dispersion Medium]

0.10 g of F10MC (trade name, manufactured by Nippon Paper Industries Co., Ltd., sodium carboxymethyl cellulose (hereinafter, also referred to as CMCNa)) was added to 100 mL of distilled water and dissolved by stirring at room temperature for 24 hours or longer, and thereby an aqueous dispersion medium containing 0.1 mass % of CMCNa was prepared.

### [Preparation of CMCNa Aqueous Solution]

2.0 g of F10MC (trade name, manufactured by Nippon Paper Industries Co., Ltd., sodium carboxymethyl cellulose) was added to 100 mL of distilled water and dissolved by stirring at room temperature for 24 hours or longer, and thereby an aqueous solution containing 2.0 mass % of CMCNa was prepared.

### [Measurement Pretreatment]

6.0 mg of carbon nanotubes was weighed into a vial bottle, and 6.0 g of the aqueous dispersion medium was added thereto. An ultrasonic homogenizer (“SmurtNR-50” manufactured by Microtec Co., Ltd.) was used for the measurement pretreatment. A tip was confirmed to be free of deterioration, after which adjustments were made such that the tip was submerged 10 mm or more from the liquid surface of the treatment sample. Homogenization was performed through auto-power driving-based ultrasonic irradiation at a constant power output with the time (irradiation time) set to 40 seconds, the power set to 50%, and the start power set to 50% (output of 50%), and thereby a carbon nanotube aqueous dispersion was prepared.

### [Measurements]

Using the carbon nanotube aqueous dispersion, the proportion of dispersed particles of carbon nanotubes having a diameter of 1 μm or less and the median diameter (D50) were measured according to the following methods.

The optical model of the LS 13 320 Universal Liquids Module was set to refractive indexes of 1.520 for carbon nanotubes and 1.333 for water, and the module was washed, after which the module was filled with 1.0 mL of the CMCNa aqueous solution.

Offset measurements, optical axis adjustments, and background measurements were carried out at a pump speed of 50%, after which the prepared carbon nanotube aqueous dispersion was added to a particle size distribution meter such that relative concentration indicating the percentage of light scattered outside the beam by the particles was from 8% to 12% or the PIDS was from 40% to 55%, ultrasonic irradiation (measurement pretreatment) was carried out for 2 minutes at 78 W by a device attached to the particle size distribution meter, circulation was carried out for 30 seconds to remove air bubbles, and then the particle size distribution was measured. A graph of vol % versus particle size (particle diameter) was obtained, and the abundance ratio of dispersed particles of 1 μm or less and the median diameter (D50) were determined.

In the measurements, three measurement samples were collected from one sample of carbon nanotubes at different collection locations, the particle size distribution was measured, and the abundance ratio of dispersed particles having a size of 1 μm or less and the median diameter (D50) were determined in terms of average values.

### <G/D Ratio of Carbon Nanotubes>

The carbon nanotubes were placed in a Raman microscope (trade name “XploRA”, manufactured by Horiba, Ltd.), and the Raman spectrum of the carbon nanotubes was measured at a laser wavelength of 532 nm. A G/D ratio of the carbon nanotubes was defined as a ratio of G/D, where, among the obtained peaks, G was the maximum peak intensity in a range of 1560 cm⁻¹ or greater and 1600 cm⁻¹ or less in the spectrum, and D was the maximum peak intensity in a range of 1310 cm⁻¹ or greater and 1350 cm⁻¹ or less.

### <Acidic Group Content of Carbon Nanotubes (CNT)>

2 g of the CNT was accurately weighed and immersed in 50 mL of a 0.01 M benzylamine/n-methylpyrrolidone solution, and dispersion treatment was performed for 1 hour with an ultrasonic irradiator. Subsequently, the mixture was centrifuged, and then the supernatant was filtered through a filter. The benzylamine remaining in the resulting filtrate was quantitatively analyzed by potentiometric titration with 0.1 M hydrochloric acid, and the obtained acidic group content per gram of CNT (mmol/g) was determined.

### <Amine Compound (E1)>

TABLE 6

| | Molecular | Boiling Point |
|---|---|---|
| Amine Compound Name | Weight | (° C.) |

| | | | |
|---|---|---|---|
| Amine 1 | Diethylamine | 73 | 55 |
| Amine 2 | Benzylamine | 107 | 185 |
| Amine 3 | Methylethanolamine | 75 | 160 |
| Amine 4 | Trioctylamine | 354 | 365 |

### <Solvent (C)>

A moisture content and amine content of the solvent that was used were respectively measured.

The moisture content and amine content were measured using a Karl Fischer moisture titrator (trade name “MKC-610”, manufactured by Kyoto Electronics Manufacturing Co., Ltd.,) and ion chromatography.
NMP1: N-methyl-2-pyrrolidone, SP value: 11.1, moisture content: 0.1 mass %, amine content: 0 mass %
NMP2: N-methyl-2-pyrrolidone, SP value: 11.1, moisture content: 1.2 mass %, amine content: 0 mass %
PGMME: SP value: 10.4, moisture content: 0.1 mass %, amine content: 0 mass %

### <Evaluation Test>

The conductive pigment pastes and mixture pastes produced in the above Examples and Comparative Examples were subjected to evaluation tests. An evaluation of D indicates non-passing. In the evaluations, a conductive pigment paste was determined to be non-passing when even one evaluation result was non-passing. The evaluation results are presented in Tables 1 and 2.

### <Dispersibility>

A dispersibility of each produced conductive pigment paste was evaluated according to the following criteria using a grind gauge in accordance with the dispersibility test set forth by JIS K-5600-2-5.
A: The pigment is dispersed at a size of less than 10 μm. The dispersibility is excellent.
B: The pigment is dispersed at a size greater than or equal to 10 μm and less than 20 μm. The dispersibility is somewhat good.
C: The pigment is dispersed at a size greater than or equal to 20 μm, but aggregates cannot be visually confirmed. The dispersibility is somewhat poor.
D: Aggregates are visually confirmed. The dispersibility is very poor.

### <Initial Viscosity>

A viscosity of each produced mixture paste was measured at a shear rate of 2.0 sec⁻¹ using a cone & plate viscometer (trade name Mars 2, manufactured by HAAKE, diameter: 35 mm, cone & plate inclined at 2°), and then evaluated according to the following criteria.
A: Viscosity is less than 10 Pa·s.

B: Viscosity is greater than or equal to 10 Pa·s and less than 20 Pa·s.

C: Viscosity is greater than or equal to 20 Pa·s and less than 50 Pa·s.

D: Viscosity is greater than or equal to 50 Pa·s.

### <Storage Stability>

The resulting mixture paste was stored at a temperature of 50° C. for two weeks, and the initial viscosity and viscosity after storage were compared. The viscosity was measured at a shear rate of 2.0 s⁻¹ using a cone & plate type viscometer (trade name Mars 2, manufactured by HAAKE, diameter: 35 mm, cone & plate inclined at 2°), the rate of increase in viscosity was determined by the following equation, and the storage stability was evaluated according to the following criteria.

Viscosity increase rate (%)=(viscosity(mPa·s) after storage)/(initial viscosity(mPa·s))×100−100
S: Viscosity increase rate (%) after storage is less than 10%.
A: Viscosity increase rate (%) after storage is greater than or equal to 10% to less than 20%.
B: Viscosity increase rate (%) after storage is greater than or equal to 20% and less than 50%.
C: Viscosity increase rate (%) after storage is greater than or equal to 50% and less than 200%.
D: Viscosity increase rate (%) after storage is greater than or equal to 200% (or not measurable due to gelling).

### <Volume Resistivity (Conductivity)>

A volume resistivity of each of the conductive pigment pastes produced in Examples 1A, 7A, 8A and 9A was further measured. In the volume resistivity measurements, a 5 mass % solution of polyvinylidene fluoride (trade name “KF Polymer W #7300”, manufactured by Kureha Corporation, solvent: N-methyl-2-pyrrolidone) was used as a binder.

The resulting conductive pigment paste and the KF Polymer W #7300 solution were weighed and measured such that a ratio of a mass of the conductive pigment (B) in the conductive pigment paste to a total mass of a solid content of the pigment dispersion resin (A) of the conductive pigment paste and a solid content of the KF Polymer W #7300 was 5:100, and the materials were then mixed for 2 minutes with an ultrasonic homogenizer, and a measurement sample was produced.

A glass plate (2 mm×100 mm×150 mm) was coated with the measurement sample by a doctor-blade method, and then heated and dried at 80° C. for 60 minutes, and a coating film was thereby formed on the glass plate. The film thickness of the resulting coating film was measured, after which the resistance value was measured with a resistivity meter (trade name “Loresta-GP MCP-T610”, manufactured by Mitsubishi Chemical Analytech Co., Ltd.) using an ASP probe (trade name “MCP-TP03P”, manufactured by Mitsubishi Chemical Analytech Co., Ltd.), and the volume resistivity was then calculated by multiplying the obtained resistance value by a resistivity correction factor (RCF) of 4.532 and the film thickness of the coating film. The volume resistivity was then evaluated according to the following criteria.
A: Volume resistivity is less than 7 Ω·cm, and conductivity is excellent.
B: Volume resistivity is greater than or equal to 7 Ω·cm and less than 15 Ω·cm, and conductivity is normal.
D: Volume resistivity is greater than or equal to 15 Ω·cm and conductivity is poor.

The conductive pigment pastes produced in Examples 1A and 7A obtained an evaluation result of “A”, and the conductive pigment pastes produced in Examples 8A and 9A obtained an evaluation result of “B”.

### [Production of Battery Electrode Layer]

### Application Examples 1 to 20

Each of the mixture pastes produced in Examples 1B to 20B was applied in a strip shape by a roller coating method to both sides of a long aluminum foil (positive electrode current collector) having an average thickness of 15 μm such that the coating weight per side was 10 mg/cm² (based on the solid content) and then dried (drying temperature: 180° C., 10 minutes) to form a positive electrode layer. The positive electrode active material layer (positive electrode layer) supported on the positive electrode current collector was rolled by a roll press machine to adjust the properties.

Each of the produced electrode layers had a residual solvent amount of less than 1%, and was an electrode layer having a favorable finish property and the like.

1. A conductive pigment paste comprising:
a pigment dispersion resin (A);
a conductive pigment (B);
a solvent (C);
a fluororesin (D); and
a high-polarity low-molecular weight component (E),
wherein
the pigment dispersion resin (A) comprises at least one polar functional group selected from the group consisting of an amide group, an imide group, a hydroxyl group, a carboxyl group, a sulfonate group, a phosphate group, a silanol group, a cyano group, and a pyrrolidone group, and a concentration of the polar functional group in the pigment dispersion resin (A) is 0.3 mmol/g or greater and 23 mmol/g or less,
the conductive pigment (B) comprises carbon nanotubes (B1), and the high-polarity low-molecular weight component (E) comprises an amine compound (E1).

2. The conductive pigment paste according to claim 1, wherein a content of the amine compound (E1) is 12 mass % or greater and 500 mass % or less based on a solid content of the conductive pigment (B) being 100 mass %.

3. The conductive pigment paste according to claim 1, wherein an acidic group content of the carbon nanotubes (B1) is 0.01 mmol/g or greater and 0.5 mmol/g or less.

4. The conductive pigment paste according to claim 1, wherein a median diameter (D50) in terms of volume of the carbon nanotubes (B1) is 10 μm or greater and 250 μm or less.

5. The conductive pigment paste according to claim 1, wherein
a BET specific surface area of the carbon nanotubes (B1) is 100 m²/g or greater and 800 m²/g or less, and
a ratio of G/D is 0.1 or greater and 5.0 or less, where, in a Raman spectrum of the carbon nanotubes (B1), G is a maximum peak intensity in a range of 1560 cm⁻¹ or greater and 1600 cm⁻¹ or less, and D is a maximum peak intensity in a range of 1310 cm⁻¹ or greater and 1350 cm⁻¹ or less.

6. The conductive pigment paste according to claim 1, wherein a moisture content of the solvent (C) is 1 mass % or less and an amine compound content of the solvent (C) is 1 mass % or less.

7. The conductive pigment paste according to claim 1, wherein a weight average molecular weight of the amine compound (E1) is less than 1000.

8. The conductive pigment paste according to claim 1, wherein an amine value of the amine compound (E1) is 105 mgKOH/g or greater and 1000 mgKOH/g or less.

9. The conductive pigment paste according to claim 1, wherein the solvent (C) is N-methyl-2-pyrrolidone.

10. The conductive pigment paste according to claim 1, wherein the conductive pigment (B) further contains acetylene black.

11. A mixture paste produced by blending the conductive pigment paste according to claim 1 and an electrode active material (F).

12. A mixture paste comprising:
a pigment dispersion resin (A);
a conductive pigment (B);
a solvent (C);
a fluororesin (D);
a high-polarity low-molecular weight component (E); and
an electrode active material (F),
wherein
the pigment dispersion resin (A) comprises at least one polar functional group selected from the group consisting of an amide group, an imide group, a hydroxyl group, a carboxyl group, a sulfonate group, a phosphate group, a silanol group, a cyano group, and a pyrrolidone group, and a concentration of the polar functional group in the pigment dispersion resin (A) is 0.3 mmol/g or greater and 23 mmol/g or less,
the conductive pigment (B) comprises carbon nanotubes (B1), and
the high-polarity low-molecular weight component (E) comprises an amine compound (E1).

13. A lithium ion battery electrode produced using the mixture paste according to claim 11.
